(19) United States
(12) Patent Application Publication
(10) Pub. No.: US 2025/0202805 A1
(43) Pub. Date: Jun. 19, 2025

(54) CONTROL DEVICE, CONTROL METHOD, AND CONTROL PROGRAM

(71) Applicant: Nippon Telegraph and Telephone Corporation, Tokyo (JP)

(72) Inventors: Yoshiki AOKI, Musashino-shi, Tokyo (JP); Takamitsu NARUMI, Musashino-shi, Tokyo (JP); Takayuki NAKAMURA, Musashino-shi, Tokyo (JP); Takeshi OSAKA, Musashino-shi, Tokyo (JP)

(21) Appl. No.: 18/847,971

(22) PCT Filed: Mar. 31, 2022
(86) PCT No.: PCT/JP2022/016904

§ 371 Date: Sep. 17, 2024

(51) Int. Cl. H04L 45/302; H04L 45/02

(52) U.S. Cl. CPC H04L 45/302; H04L 45/02

(57) ABSTRACT

A controller (200) includes a determination unit (222), a setting unit (223), and a resource request unit (224). The determination unit (222) determines a path or a transmission timing of a flow in which an opening time of a non-priority gate extends while avoiding congestion of priority packets based on the acquired information. The setting unit (223) sets the path or the transmission timing of the priority packet determined by the determination unit (222) to a transmission terminal (10) or a transfer device (40).

### TECHNICAL FIELD

The present invention relates to a control device, a control method, and a control program.

### BACKGROUND ART

In 5G environments, there are cases where packets having various QoS requests are transferred in one network slice. Priority packets requiring real-time performance such as robot control at remote locations are transferred with priority over other non-priority packets not requiring real-time performance in order to guarantee communication delay and delay fluctuation values (jitters).

There is a function such as the time aware shaper (TAS) defined in IEEE 802.1Qbv in order to guarantee delay fluctuation values of a priority flow. In a TAS, there has been proposed a scheme of reducing a queuing delay of a priority packet by closing a gate for a non-priority packet in advance in a time slot in which a priority packet transmitted periodically arrives at a transfer device (see, for example, PTL 1).

### CITATION LIST

### Patent Literature

[PTL 1] Japanese Patent Application Publication No. 2018-129661

### SUMMARY OF INVENTION

### Technical Problem

However, in a technology of the related art, congestion of priority packets cannot be avoided, and an opening time of a non-priority gate cannot be guaranteed. For example, when the TAS is used, a timing at which each transfer device closes the non-priority gate can be synchronized, but control of a communication path and a transmission timing of flowing priority traffic is not performed. Accordingly, there is a possibility of priority packets becoming concentrated and arriving at a specific time, causing a priority packet queue to become full, and a possibility of priority packets arriving at various timings, causing a non-priority gate to be continuously closed and increasing an influence on the non-priority packet.

A user of a network slice can reduce a use fee of the slice by minimizing network resources to be used, but it is necessary to perform control for guaranteeing the number of priority flows to be accommodated with a smaller number of network resources.

The present invention has been devised in view of the foregoing circumstances and an object of the present invention is to guarantee an opening time of a non-priority gate while avoiding congestion of priority packets.

### Solution to Problem

In order to solve the above-described problem and achieve the object, a control device according to an aspect of the present invention includes: an acquisition unit configured to acquire topology information indicating a connection form of a network and information regarding transfer delay of each transfer device transferring a priority packet and a non-priority packet; a determination unit configured to determine a path or a transmission timing of a flow of the priority packet based on the topology information acquired by the acquisition unit and information regarding transfer delay of each transfer device; and a setting unit configured to set the path or the transmission timing of the flow determined by the determination unit in the transfer device or the transmission terminal.

### Advantageous Effects of Invention

According to the present invention, it is possible to provide a controller guaranteeing an opening time of a non-priority gate while avoiding congestion of priority packets.

### BRIEF DESCRIPTION OF DRAWINGS

FIG. 1 is a diagram illustrating an example of a configuration of a control system according to an embodiment.

FIG. 2 is a diagram illustrating an example of a configuration of a control device according to the embodiment.

FIG. 3 is a diagram illustrating an example of an additional flow transfer procedure according to the embodiment.

FIG. 4 is a diagram illustrating an example of a flow control by route setting according to the embodiment.

FIG. 5 is a diagram illustrating an example of flow control by transmission timing setting according to the embodiment.

FIG. 6 is a flowchart illustrating an example of flow control by the control device according to the embodiment.

FIG. 7 is a diagram illustrating a computer that performs a control program according to the embodiment.

### DESCRIPTION OF EMBODIMENTS

An embodiment of the present invention will be described in detail below with reference to the drawings. The present invention is not limited by the embodiment. In description of the drawings, the same portions are denoted by the same reference numerals and repeated description will be omitted.

### [1. Configuration Example of Control System]

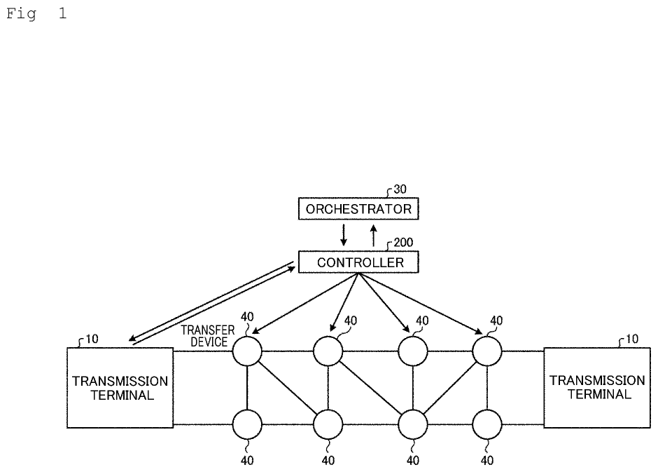

First, a configuration of the control system 1 will be described with reference to FIG. 1. FIG. 1 is a diagram illustrating an example of a configuration of a control system 1 according to an embodiment. The system illustrated in FIG. 1 includes a transmission terminal 10, a controller (control device) 200, an orchestrator 30, and a transfer device 40. The control system 1 may be implemented by a plurality of devices. When the control system 1 is implemented by a plurality of devices, constituent elements of the control system 1 may be distributed to the plurality of devices in any way.

First, the transmission terminal 10 requests the controller 200 to add an additional request of a new flow. The transmission terminal 10 transmits a flow according to a setting of a transmission timing received from the controller 200. Next, the controller 200 receives the addition request of the new flow from the transmission terminal 10 and performs calculation. Here, when the resources are calculated to be insufficient, the controller 200 requests the orchestrator 30 to add resources. The controller 200 sets flow control in the transmission terminal 10 or the transfer device 40. Details of the controller 200 will be described below.

Next, the orchestrator 30 is an external device that manages slices. The orchestrator 30 receives a resource addition request from the controller 200 and adds resources. Then, the plurality of transfer devices 40 are located on a network, receive a flow transmitted from the transmission terminal 10, and perform transfer of the flow.

### [2. Configuration Example of Controller]

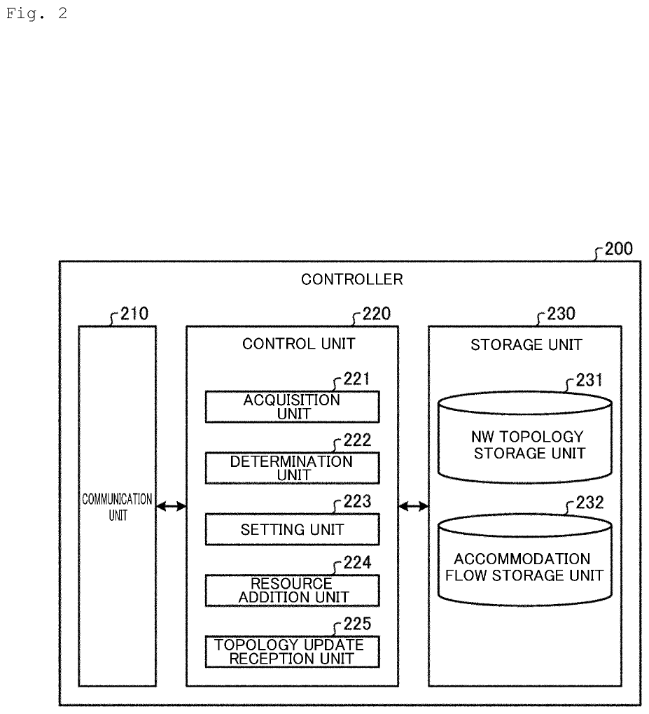

Next, an example of a configuration of the controller 200 will be described with reference to FIG. 2. FIG. 2 is a diagram illustrating an example of a configuration of the controller 200 according to the embodiment. As illustrated in FIG. 2, the controller 200 includes a communication unit 210, a control unit 220, and a storage unit 230. The above-mentioned respective units may be dispersed and held in the plurality of devices. Hereinafter, processing of each of the units will be described below.

The communication unit 210 is implemented with, for example, a network interface card (NIC), and enables communication between the control unit 220 and the external device via an electric communication line such as a local area network (LAN) or the Internet. For example, the communication unit 210 enables communication between the transfer device 40 or the external device, and the control unit 220.

The storage unit 230 is implemented by a semiconductor memory element such as a random access memory (RAM) or a flash memory, or a storage device such as a hard disk or an optical disc. Here, the storage unit 230 includes an NW topology storage unit 231 and an accommodation flow storage unit 232.

The NW topology storage unit 231 stores topology information which is network configuration information, a delay time of each transfer device 40, a maximum flow rate, and information regarding a minimum opening time of a non-priority gate. The accommodation flow storage unit 232 stores a target delay time of the already accommodated flow, a transmission source node, and information regarding the transmission destination node. The above is exemplary, and information stored in the NW topology storage unit 231 and the accommodation flow storage unit 232 is not limited to that described here.

The control unit 220 is implemented using a central processing unit (CPU), a network processor (NP), a field programmable gate array (FPGA), or the like and executes a processing program stored in a memory. Accordingly, the control unit 220 functions as an acquisition unit 221, a determination unit 222, a setting unit 223, a resource request unit 224, and a topology update reception unit 225. These functional units may be mounted on different hardware. The control unit 220 may include another functional unit.

The acquisition unit 221 acquires topology information indicating a network connection form and information regarding transfer delay of each transfer device that transfers a priority packet and a non-priority packet. The acquisition unit 221 further acquires information regarding a minimum opening time of a non-priority gate in each transfer device. For example, the acquisition unit 221 acquires topology information indicating a network connection form, transfer delay of the transfer device 40, a maximum flow rate, and the minimum opening time of the non-priority gate from the NW topology storage unit 231. The acquisition unit 221 acquires a target delay time of the accommodated flow and information regarding a transmission source node and a transmission destination node from the accommodation flow storage unit 232. When there is a new flow addition request from the transmission terminal 10, the acquisition unit 221 acquires information regarding a transmission source node of a new flow, a transmission destination node, and a target delay time from the transmission terminal 10.

The determination unit 222 determines a path or a transmission timing of a flow of the priority packet based on the topology information acquired by the acquisition unit 221 and information regarding transfer delay of each transfer device 40. The determination unit 222 determines a path or a transmission timing of a flow in which a delay time until transmission of the flow from a transmission source node to a transmission destination node is within a target delay time preset for each flow and an opening time of the non-priority gate is equal to or greater than a minimum opening time set in the non-priority gate based on the topology information acquired by the acquisition unit 221, the transmission delay of each transfer device 40, and the information regarding the minimum opening time of the non-priority gate.

For example, the determination unit 222 determines the path or the transmission timing of the flow based on the information stored in the storage unit 230 and the information notified of by the transmission terminal 10. Here, the transmission timing is a timing at which the transfer device 40 transfers the flow. The transmission timing is not limited to the above and may be a timing at which the transmission terminal 10 transmits the flow.

As a specific process, for example, the determination unit 222 determines a flow path or a transmission timing at which the delay time until transmission of the flow from the transmission source node to the transmission destination node is within the target time of the flow and a capacity or more is not transmitted to the same transfer device 40 in the same period based on the topology information indicating the network connection form of the NW topology storage unit 231, the information regarding the transfer delay of the transfer device 40 and the minimum opening time of the non-priority gate, and the information regarding the transmission source node, the transmission destination node, and the target delay time of the flow notified of by the transmission terminal 10.

At this time, the determination unit 222 may calculate the route and the transmission timing by utilizing an optimal solution which is a calculation result by a linear programming problem solver. For example, the determination unit 222 establishes a linear programming problem using the following objective function, constraint conditions, and variables, delivers the linear programming problem to the linear programming problem solver, and receives a return of a result of the variables based on information regarding the topology information, the transfer delay of the transfer device 40, and the minimum opening time of the non-priority gate, and information regarding the transmission source node, the transmission destination node, and the target delay time of the flow notified of by the transmission terminal 10.

The objective function of the linear programming problem is set, for example, a function of minimizing a closing time of a non-priority gate at a node, minimizing packets that do not satisfy QoS, and minimizing the closing time of the non-priority gate in the node in all the time slots as in the following Formula (1).

$$[ Math . 1 ]$$

$$minimize {\sum }_{v ∈ V} {closerate}_{v} + δ \times {\sum }_{k ∈ K} {block}_{k} + ε \times {\sum }_{t ∈ T} {\sum }_{v ∈ V} {close}_{v , t} \qquad ( 1 )$$

The constraint conditions include a topology, a transfer capacity, information regarding a traffic amount, a path, and target delay of each flow, and the minimum opening time of the non-priority gate at each node. The variables include a path of a flow and a transmission timing, and a real number solution is obtained. In this way, the determination unit 222 determines the path or the transmission timing of the flow in which an opening time of the non-priority gate is guaranteed while avoiding congestion of the priority packet. As a specific process, for example, the determination unit 222 performs calculation using all the flows as variables when the network is in the initial state. Conversely, when the network is not in the initial state, the determination unit 222 performs calculation using the existing flows as constants and additional flows as variables. Through the calculation, the determination unit 222 determines a path or a transmission timing of a flow in which an opening time of a non-priority gate is guaranteed while avoiding congestion of priority packets.

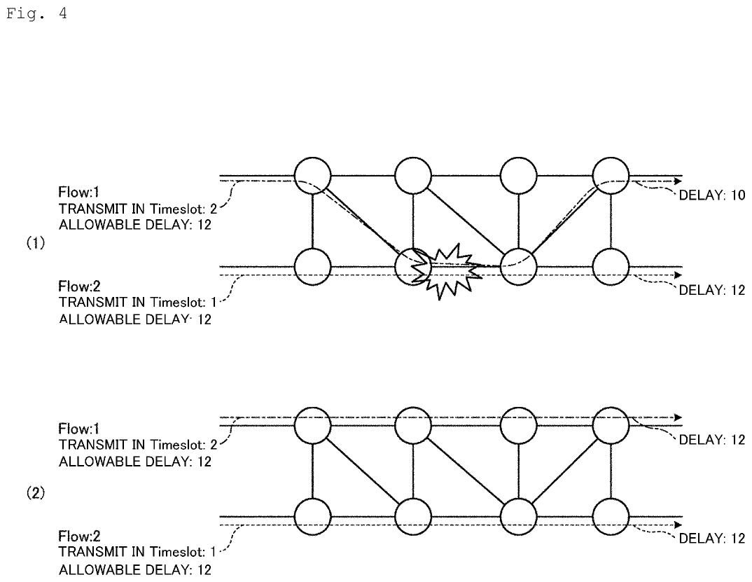

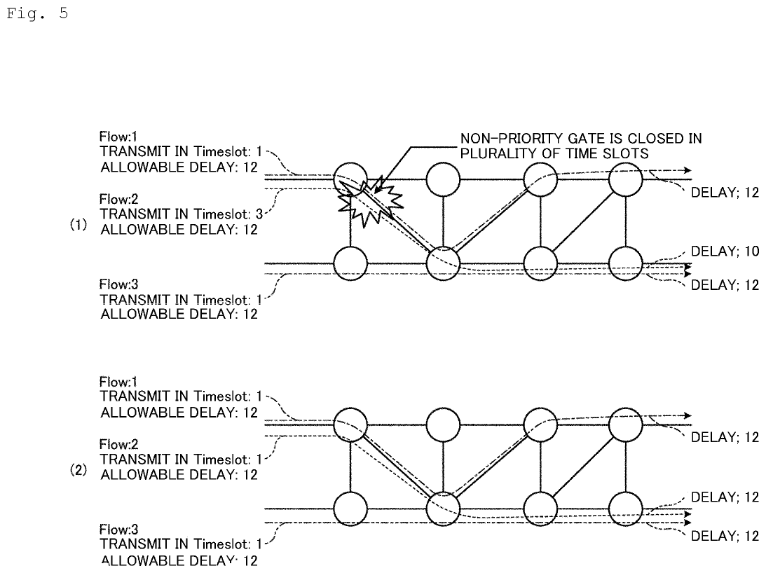

The setting unit 223 sets the path or the transmission timing of the flow determined by the determination unit 222 in the transfer device 40 or the transmission terminal 10. The setting unit 223 sets a timing at which the flow of the transfer device 40 is transferred as the transmission timing determined by the determination unit 222. The setting unit 223 sets a timing for the flow of the transmission terminal 10 is to be transmitted as the transmission timing determined by the determination unit 222. A specific example will be described below with reference to FIGS. 4 and 5.

As a result of calculation by the determination unit, the resource request unit 224 requests the external device to add resources when, the determination unit cannot determine the path or the transmission timing of the flow in which in which the delay time until transmission of the flow from the transmission source node to the transmission destination node is within the target delay time preset for each flow and the opening time of the non-priority gate is equal to or greater than the minimum opening time set in the non-priority gate. Here, the orchestrator 30 or the like is exemplified as an external device which the resource request unit 224 requests to add the resources.

For example, the resource request unit 224 requests the external device to add resources necessary to determine the path or the transmission timing of the flow in which in which the delay time until transmission of the flow from the transmission source node to the transmission destination node is within the target delay time preset for each flow and the opening time of the non-priority gate is equal to or greater than the minimum opening time set in the non-priority gate.

The topology update reception unit 225 receives an update of the topology information indicating the network connection form and stores the topology information in the NW topology storage unit 231. For example, when the network connection form is changed, the topology update reception unit 225 receives a notification of the update of the topology and stores new topology information in the NW topology storage unit 231.

### [3. Transfer Procedure of Additional Flow]

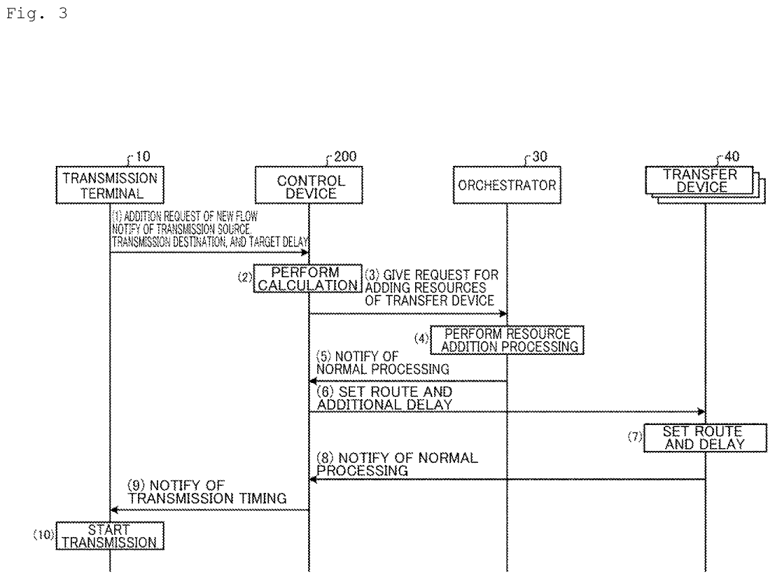

Next, a procedure until transfer of a flow by the control system 1 will be described with reference to FIG. 3. FIG. 3 is a diagram illustrating an example of a procedure until transfer of a flow by the control system 1 according to the embodiment. As illustrated in FIG. 3, the control system according to the embodiment includes a transmission terminal 10, a controller 200, an orchestrator 30, and a transfer device 40.

First, the transmission terminal 10 requests the controller 200 to add a flow (1). At this time, the transmission terminal 10 notifies the controller 200 of information regarding the transmission source node and the transmission destination node of the flow in which the request for the resources is given, and the target delay. Subsequently, the controller 200 determines the path or the transmission timing of the flow based on the transmission source node, the transmission destination node, and the target delay of the flow notified of by the transmission terminal 10, the stored topology information, and the information regarding the transfer delay of the transfer device 40 (2). Here, when the path or the transmission timing of the flow cannot be determined, the controller 200 determines that the resources are insufficient and requests the orchestrator 30 to add minimum resources (3).

Subsequently, the orchestrator 30 receiving the request for adding the minimum resources from the controller 200 performs resource addition processing (4). Thereafter, the orchestrator 30 notifies the controller 200 that the resource addition processing has been normally performed (5).

Subsequently, the controller 200 sets the determined path or transmission timing of the flow to the transfer device 40 (6). Accordingly, the path or the transmission timing of the flow is set in the transfer device 40 (7). Subsequently, the transfer device 40 notifies the controller 200 that the path or the transmission timing of the flow is normally set (8). Subsequently, the controller 200 sets the transmission timing of the flow in the transmission terminal 10 (9). Then, the transmission terminal 10 starts transmitting the flow (10).

### [4. Flow Control by Route Setting]

Next, efficiency of the flow transfer through the path setting will be described with reference to FIG. 4. FIG. 4 is a diagram illustrating efficiency of flow transfer by the controller 200. In the following example, 12 is set as a target delay time in each of Flow 1 and Flow 2. FIG. 4 (1) illustrates a transfer example of a flow which is not controlled, and illustrates Flow 1 and Flow 2.

Here, since a delay time of Flow 1 is 10 and a delay time of Flow 2 is 12, any flow is transferred within the target delay time. However, traffic collision may occur because a path of Flow 1 and a path of Flow 2 partially overlap. At this time, when a total amount of the collided traffic exceeds a maximum flow rate of the transfer device 40, congestion occurs.

On the other hand, FIG. 4 (2) illustrates a transfer example of the flow controlled through the route setting, and illustrates Flow 1 and Flow 2. Here, the controller 200 performs flow control to perform the route setting in which Flow 1 and Flow 2 can be transferred within the target delay time, and the overlapping between the path of Flow 1 and the path of Flow 2 is solved.

Specifically, the controller 200 first guarantees the minimum opening time of each non-priority gate and calculates a path and a transmission timing of a flow in which the closing time of the non-priority gate is minimized while avoiding congestion. Then, the controller 200 transfers Flow 1 and Flow 2 from the transmission source node to the transmission destination node within each target delay time by setting the path obtained through the calculation in the transfer device 40, and further avoids congestion occurring because the total amount of collision traffic exceeds a maximum flow rate of the transfer device 40. Accordingly, the controller 200 guarantees the minimum opening time of the non-priority gate by reducing a load on the transfer device 40, and maximizes transfer efficiency of the flow.

### [5. Flow Control by Transmission Timing Setting]

Next, efficiency of flow transfer through setting of a transmission timing will be described with reference to FIG. 5. FIG. 5 is a diagram illustrating efficiency of flow transfer by the controller 200. In the following example, 12 is set as a target delay time in each of Flow 1, Flow 2 and Flow 3.

FIG. 5 (1) illustrates a transfer example of a flow which is not controlled and illustrates Flow 1, Flow 2, and Flow 3. Here, since the delay time of Flow 1 is 12, the delay time of Flow 2 is 10, and the delay time of Flow 3 is 12, the flows are all transferred within the target delay time of the flow. However, since the transmission timing is not appropriate, a load is applied to the transfer device 40, and the non-priority gate is closed in a plurality of time slots. In this way, a problem arises in that congestion of non-priority packets increases due to an increase in the closing time of the non-priority gate.

On the other hand, FIG. 5 (2) illustrates a transfer example of a flow controlled by setting the transmission timing and illustrates Flow 1, Flow 2, and Flow 3. Here, the controller 200 performs flow control by setting the transmission timing of the flow in the transmission terminal 10 or the transfer device 40, sets the transmission timing at which Flow 1, Flow 2, and Flow 3 are transferred within the target delay time, and reduces the closing time of the non-priority gate.

Specifically, the controller 200 first guarantees the minimum opening time of each non-priority gate and calculates the path and the transmission timing of the flow in which the closing time of the non-priority gate is minimized while avoiding congestion. Then, the controller 200 sets the transmission timing obtained through the calculation in the transmission terminal 10 or the transfer device 40. Accordingly, the controller 200 guarantees the minimum opening time of the non-priority gate and maximizes the transfer efficiency of the flow by transferring Flow 1, Flow 2, and Flow 3 from the transmission source node to the transmission destination node within each target delay time and further reducing the load on the transfer device 40.

### [6. Flowchart]

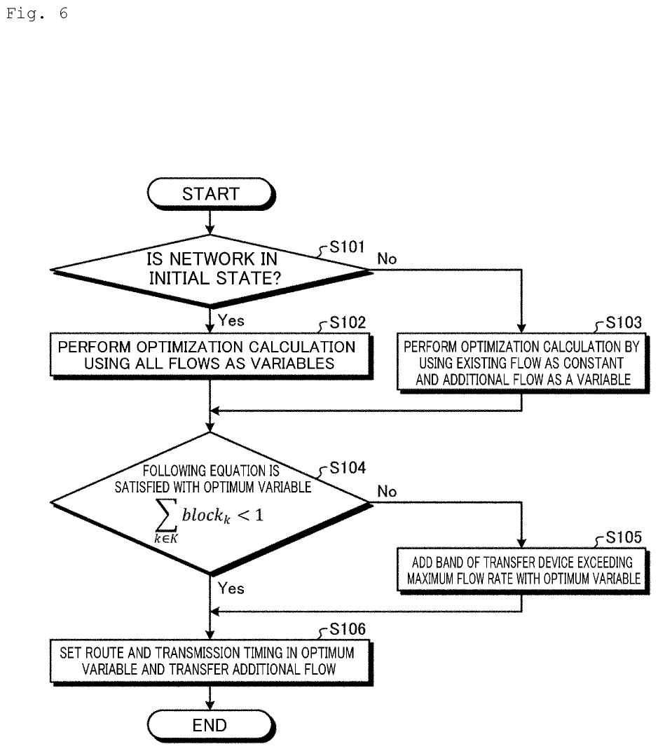

Next, a flow of flow control by the controller 200 will be described with reference to FIG. 6. FIG. 6 is a flowchart illustrating an example of a flow of flow control according to the embodiment.

The determination unit 222 first determines whether the network is in the initial state (step S101). At this time, when the network is in the initial state (step S101: “Yes”), the determination unit 222 performs optimization calculation using all flows as variables (step S102). Specifically, the determination unit 222 performs the optimization calculation for minimizing the closing time of the non-priority gate while guaranteeing the minimum opening time of each non-priority gate and avoiding congestion using the paths and transmission timings of all the flows as variables.

When the network is not in the initial state (step S101: “No”), the optimization calculation is performed using the existing flows as constants and the additional flows as variables (step S103). Specifically, the determination unit 222 performs optimization calculation for minimizing the closing time of the non-priority gate while guaranteeing the minimum opening time of each non-priority gate and avoiding congestion using the path and the transmission timing of the existing flow as a constant and the path and the transmission timing of the additional flow as a variable.

Next, as a result of the calculation, it is determined whether an optimum variable satisfies the following Formula (2) (step S104). Here, when the optimum variable does not satisfy the following Formula (2) (step S104: “No”), it is meant that resources are insufficient. Conversely, when the optimum variable satisfies the following Formula (2) (step S104: “Yes”), it is meant that the resources are not insufficient.

Here, when the optimum variable does not satisfy the following Formula (2) (step S104 “No”), the resource request unit 224 makes a request for adding a band to the transfer device 40 exceeding the maximum flow rate with the optimum variable (step S105). Then, when the optimum variable satisfies the following Formula (2) (step S104 “Yes”) or after the processing of step S105 ends, the setting unit 223 sets the path or the transmission timing with the optimum variable in the transfer device 40 or sets the transmission timing with the optimum variable in the transmission terminal 10, and transfers the flow (step S106).

$$[ Math . 2 ]$$

$${\sum }_{k ∈ K} {block}_{k} < 1 \qquad ( 2 )$$

### [7. Effects]

As described above, the controller 200 according to the embodiment includes the acquisition unit 221, the determination unit 222 and the setting unit 223. The acquisition unit 221 acquires topology information indicating a network connection form and information regarding transfer delay of each transfer device 40 transferring a priority packet and a non-priority packet. The determination unit 222 determines a path or a transmission timing of a flow of the priority packet based on the topology information acquired by the acquisition unit 221 and information regarding transfer delay of each transfer device 40. The setting unit 223 sets the path or the transmission timing of the flow determined by the determination unit 222 to the transfer device 40 or the transmission terminal 10.

Accordingly, the controller 200 according to the embodiment can maximize the transfer efficiency of a priority flow based on the acquired information, and can avoid congestion of the priority flow. That is, the controller 200 can maximize transfer efficiency of the flow and minimizes an influence on a non-priority packet while preventing collision of priority packets by setting a path or a transmission timing of a flow in the transmission terminal 10 or the transfer device 40 by using collected information.

Accordingly, the controller 200 according to the embodiment can guarantee the minimum opening time of the non-priority gate. Accordingly, the controller 200 according to the embodiment can minimize use resources and reduce a slice use fee of a service provider using the slice.

In a controller 200 according to an embodiment, a setting unit 223 sets timing for transferring a flow to a transfer device 40 to control flow transfer. Thus, the controller 200 according to the embodiment performs flow control by the transfer device 40, and can reduce the closing time of the non-priority gate.

In the controller 200 according to the embodiment, the setting unit 223 sets a timing at which a flow is transmitted to a transmission terminal 10 and controls flow transfer. Accordingly, the controller 200 according to the embodiment performs flow control by the transmission terminal 10, and can reduce the closing time of the non-priority gate.

In the controller 200 according to an embodiment, the acquisition unit 221 further acquires information regarding the minimum opening time of a non-priority gate in the transfer device 40. Based on the topology information acquired by the acquisition unit 221, the transfer delay of the transfer device 40, and information regarding the minimum opening time of the non-priority gate, the determination unit 222 determines a path or a transmission timing of the flow in which a delay time until transmission of the flow from a transmission source node to a transmission destination node is within a target delay time preset for each flow and an opening time of the non-priority gate is equal to or greater than a minimum opening time set in the non-priority gate. The controller further includes the resource request unit 224 that requests an external device to add resources when, as a result calculated by the determination unit 222, the determination unit is not able to determine the path or the transmission timing of the flow in which the delay time until transmission of the flow from the transmission source node to the transmission destination node is within the target delay time preset for each flow and the opening time of the non-priority gate is equal to or greater than the minimum opening time set in the non-priority gate.

Accordingly, the controller 200 according to the embodiment can solve the insufficient resources by requesting resources to the orchestrator 30. Accordingly, the controller 200 according to the embodiment can avoid congestion of priority packets due to the insufficient resources.

In the controller 200 according to the embodiment, the resource request unit 224 requests the orchestrator 30 to add resources necessary to determine the path or the transmission timing of the flow in which the delay time until transmission of the flow from the transmission source node to the transmission destination node is within the target delay time preset for each flow and the opening time of the non-priority gate is equal to or greater than the minimum opening time set in the non-priority gate.

Thus, a controller 200 according to the embodiment requests minimum resources from the orchestrator 30 when the resources are insufficient, and thus, the insufficient resources can be solved. Further, the controller 200 according to the embodiment can minimize an increase in a use fee of the slice for a service provider using the slice.

### [8. Program]

A program that describes processing executed by the controller 200 described in the foregoing embodiment in a computer-executable language can also be generated. In this case, the same effects as those of the foregoing embodiment may be obtained by a computer executing the program. Further, processes similar to those of the foregoing embodiment may be also implemented by recording the program in a computer-readable recording medium, and causing a computer to load and execute the program recorded on this recording medium.

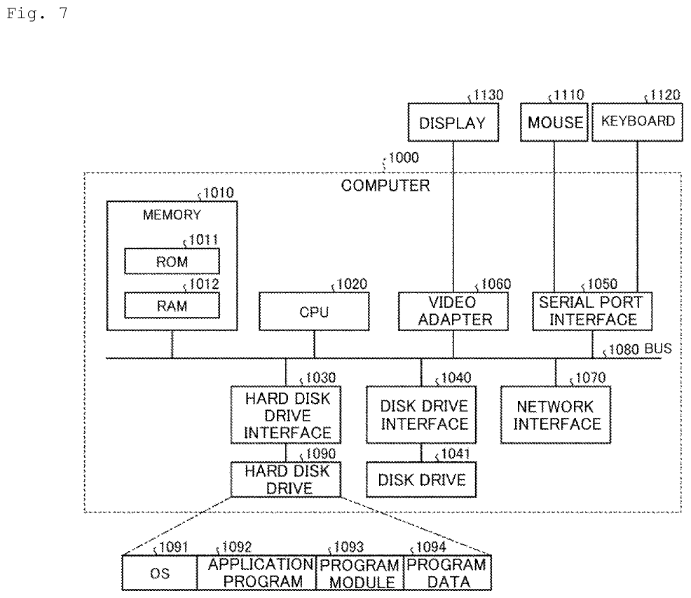

FIG. 7 is a diagram illustrating an example of a computer that executes a program. As illustrated in FIG. 7, for example, a computer 1000 includes a memory 1010, a CPU 1020, a hard disk drive interface 1030, a disk drive interface 1040, a serial port interface 1050, a video adapter 1060, and a network interface 1070. These units are connected to each other by a bus 1080.

The memory 1010 includes a read only memory (ROM) 1011 and a RAM 1012. The ROM 1011 stores, for example, a boot program such as a basic input output system (BIOS). The hard disk drive interface 1030 is connected to a hard disk drive 1090. The disk drive interface 1040 is connected to a disk drive 1041. A removable storage medium such as a magnetic disk or an optical disc is inserted into the disk drive 1041. A mouse 1110 and a keyboard 1120 are connected to the serial port interface 1050, for example. For example, a display 1130 is connected to the video adapter 1060.

Here, as illustrated in FIG. 7, for example, the hard disk drive 1090 stores an OS 1091, an application program 1092, a program module 1093, and program data 1094. Each table described in the foregoing embodiment is stored in, for example, the hard disk drive 1090 or the memory 1010.

The control program is stored in the hard disk drive 1090 as the program module in which commands executed by the computer 1000 are described, for example. Specifically, the program module 1093 in which each type of processing executed by the controller 200 described in the foregoing embodiment is described is stored in the hard disk drive 1090.

The data used for information processing by the control program is stored in, for example, the hard disk drive 1090 as the program data. The CPU 1020 reads the program module 1093 and the program data 1094 stored in the hard disk drive 1090 to the RAM 1012 as necessary, and performs each of the above-described procedures.

The program module 1093 and the program data 1094 related to the control program need not be stored in the hard disk drive 1090, and may also be stored in, for example, a removable storage medium and read by the CPU 1020 via a disk drive 1041 or the like. Alternatively, the program module 1093 and the program data 1094 related to the control program may be stored in another computer connected via a network such as a local area network (LAN) or a wide area network (WAN) and may be read by the CPU 1020 via the network interface 1070.

### REFERENCE SIGNS LIST

1 Control system
10 Transmission terminal
200 Controller (control device)
210 Communicating unit
220 Control module
221 Acquisition unit
222 Determination unit
223 Setting unit
224 Resource request unit
225 Topology update reception unit
230 Storage unit
231 NW Topology storage unit
232 Accommodation flow storage unit
30 Orchestrator
40 Transfer device

1. A control device comprising:
an acquisition unit, including one or more processors, configured to acquire topology information indicating a connection form of a network and information regarding transfer delay of each transfer device transferring a priority packet and a non-priority packet;
a determination unit, including one or more processors, configured to determine a path or a transmission timing of a flow of the priority packet based on the topology information acquired by the acquisition unit and information regarding transfer delay of each transfer device; and
a setting unit, including one or more processors, configured to set the path or the transmission timing of the flow determined by the determination unit in the transfer device or the transmission terminal.

2. The control device according to claim 1, wherein the setting unit is configured to set a timing at which the flow of the transfer device is transferred as the transmission timing determined by the determination unit.

3. The control device according to claim 1, wherein the setting unit is configured to set a timing at which the flow of the transmission terminal is transmitted as the transmission timing determined by the determination unit.

4. The control device according to claim 1,
wherein the acquisition unit is further configured to acquire information regarding a minimum opening time of a non-priority gate in each transfer device;
wherein, based on the topology information acquired by the acquisition unit, the transfer delay of each transfer device, and the information regarding the minimum opening time of a non-priority gate, the determination unit is configured to determine a path or a transmission timing of the flow in which a delay time until transmission of the flow from a transmission source node to a transmission destination node is within a target delay time preset for each flow and an opening time of the non-priority gate is equal to or greater than a minimum opening time set in the non-priority gate; and
wherein the control device further comprises a resource request unit, including one or more processors, configured to request an external device to add resources when a result calculated by the determination unit indicates that the determination unit is not able to determine the path or the transmission timing of the flow in which the delay time until transmission of the flow from the transmission source node to the transmission destination node is within the target delay time preset for each flow and the opening time of the non-priority gate is equal to or greater than the minimum opening time set in the non-priority gate.

5. The control device according to claim 4, wherein the resource request unit is configured to request the external device to add resources necessary to determine the path or the transmission timing of the flow in which the delay time until transmission of the flow from the transmission source node to the transmission destination node is within the target delay time preset for each flow and the opening time of the non-priority gate is equal to or greater than the minimum opening time set in the non-priority gate.

6. A control method comprising:
an acquisition step of acquiring topology information indicating a connection form of a network and information regarding transfer delay of each transfer device transferring a priority packet and a non-priority packet;
a determination step of determining a path or a transmission timing of a flow of the priority packet based on the topology information acquired in the acquisition step and information regarding transfer delay of each transfer device; and
a setting step of setting the path or the transmission timing of the flow determined in the determination step in the transfer device or the transmission terminal.

7. A non-transitory computer-readable storage medium storing a control program causing a computer to perform:
an acquisition step of acquiring topology information indicating a connection form of a network and information regarding transfer delay of each transfer device transferring a priority packet and a non-priority packet;
a determination step of determining a path or a transmission timing of a flow of the priority packet based on the topology information acquired in the acquisition step and information regarding transfer delay of each transfer device; and
a setting step of setting the path or the transmission timing of the flow determined in the determination step in the transfer device or the transmission terminal.

8. The control method according to claim 6, wherein the setting step comprises setting a timing at which the flow of the transfer device is transferred as the transmission timing determined by the determination step.

9. The control method according to claim 6, wherein the setting step comprises setting a timing at which the flow of the transmission terminal is transmitted as the transmission timing determined by the determination step.

10. The control method according to claim 6,
wherein the acquisition step comprises acquiring information regarding a minimum opening time of a non-priority gate in each transfer device;
wherein the determination step comprises determining, based on the topology information acquired by the acquisition step, the transfer delay of each transfer device, and the information regarding the minimum opening time of a non-priority gate, a path or a transmission timing of the flow in which a delay time until transmission of the flow from a transmission source node to a transmission destination node is within a target delay time preset for each flow and an opening time of the non-priority gate is equal to or greater than a minimum opening time set in the non-priority gate; and
wherein the control method further comprises a resource request step of requesting an external device to add resources when a result calculated by the determination step indicates that the determination step is not able to determine the path or the transmission timing of the flow in which the delay time until transmission of the flow from the transmission source node to the transmission destination node is within the target delay time preset for each flow and the opening time of the non-priority gate is equal to or greater than the minimum opening time set in the non-priority gate.

11. The control method according to claim 10, wherein the resource request step comprises requesting the external device to add resources necessary to determine the path or the transmission timing of the flow in which the delay time until transmission of the flow from the transmission source node to the transmission destination node is within the target delay time preset for each flow and the opening time of the non-priority gate is equal to or greater than the minimum opening time set in the non-priority gate.

12. The non-transitory computer-readable storage medium according to claim 7, wherein the setting step comprises setting a timing at which the flow of the transfer device is transferred as the transmission timing determined by the determination step.

13. The non-transitory computer-readable storage medium according to claim 7, wherein the setting step comprises setting a timing at which the flow of the transmission terminal is transmitted as the transmission timing determined by the determination step.

14. The non-transitory computer-readable storage medium according to claim 7,
wherein the acquisition step comprises acquiring information regarding a minimum opening time of a non-priority gate in each transfer device;
wherein the determination step comprises determining, based on the topology information acquired by the acquisition step, the transfer delay of each transfer device, and the information regarding the minimum opening time of a non-priority gate, a path or a transmission timing of the flow in which a delay time until transmission of the flow from a transmission source node to a transmission destination node is within a target delay time preset for each flow and an opening time of the non-priority gate is equal to or greater than a minimum opening time set in the non-priority gate; and
wherein the control method further comprises a resource request step of requesting an external device to add resources when a result calculated by the determination step indicates that the determination step is not able to determine the path or the transmission timing of the flow in which the delay time until transmission of the flow from the transmission source node to the transmission destination node is within the target delay time preset for each flow and the opening time of the non-priority gate is equal to or greater than the minimum opening time set in the non-priority gate.

15. The non-transitory computer-readable storage medium according to claim 14, wherein the resource request step comprises requesting the external device to add resources necessary to determine the path or the transmission timing of the flow in which the delay time until transmission of the flow from the transmission source node to the transmission destination node is within the target delay time preset for each flow and the opening time of the non-priority gate is equal to or greater than the minimum opening time set in the non-priority gate.
